(19) United States
(12) Patent Application Publication
(10) Pub. No.: US 2016/0036985 A1
(43) Pub. Date: Feb. 4, 2016

(54) REAL-TIME RULE-BASED RECOVERY PLATFORM

(71) Applicants: Nir Koren, Ra' anana (IL); Ofra Efrati, Ra' anana (IL)

(72) Inventors: Nir Koren, Ra' anana (IL); Ofra Efrati, Ra' anana (IL)

(21) Appl. No.: 14/446,915

(22) Filed: Jul. 30, 2014

(51) Int. Cl. H04M 3/54; G06Q 10/00; G06Q 10/06; G06Q 30/00

(52) U.S. Cl. CPC H04M 3/54; G06Q 30/016; G06Q 10/20; G06Q 10/0631

(57) ABSTRACT

A method, medium, and system to receive information indicative of a monitored entity's state of operation, determine whether to perform an action in response to the received information and a set of criteria rules, the action including at least one of to repair an issue indicated in the received information and to redirect a call to the monitored entity to a different entity, in an instance it is determined to redirect a call to the monitored entity to a different entity, automatically redirect the call to the different entity based on at least one redirect rule; and save a record of at least the determination of whether to perform an action, the action taken, and the redirecting of the call.

### BACKGROUND

Software applications and systems may be developed and deployed for providing a service to customers of a service provider. It may be a challenge to keep the deployed systems, services, and applications continuously available. Part of the challenge may be attributable to establishing the system, determining problems with the system as they occur that may impact an availability of the system, and recovering from the problems as soon as possible.

In some contexts, such as a cloud-based system, service, or application, there may be an expectation of continuous availability by users of the system, service, or application. Accordingly, any down time of the system, service, or application may have the unwanted effect of reflecting poorly on the service provider of the subject system, service, or application.

### BRIEF DESCRIPTION OF THE DRAWINGS

FIG. 1 is a block diagram of a system, according to some embodiments;

FIG. 2 is an illustrative depiction of a platform, according to some embodiments;

FIG. 3 is a block diagram, in accordance with some embodiments;

FIG. 4 is a flow diagram of a process, according to some embodiments;

FIG. 5 is a flow diagram of a process, according to some embodiments; and

FIG. 6 is a block diagram of a computing device, in accordance with some embodiments.

### DETAILED DESCRIPTION

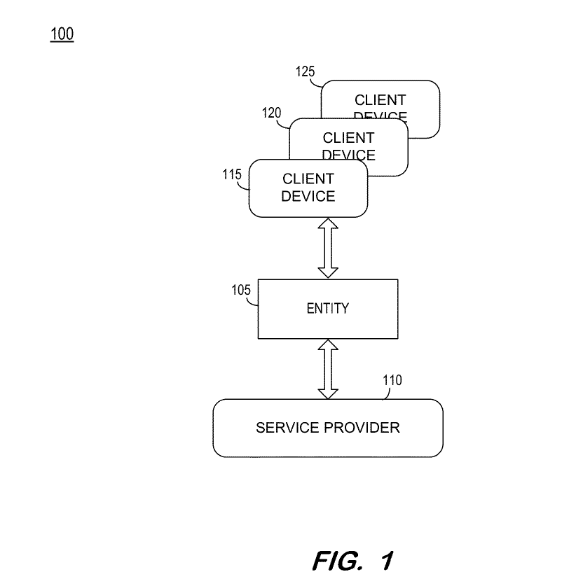

FIG. 1 is a block diagram of a system 100, according to some embodiments herein. System 100 represents a logical architecture for describing processes and a framework for a real-time rule based recovery platform to provide a mechanism to monitor a status of an entity, determine a cause of an issue/state of the monitored entity, take a recovery action in response to the determined state, including redirecting a call to a different entity, and recording, at least, the recovery action performed. Actual implementations of system 100 may include more or different components arranged in other manners than that shown in FIG. 1.

System 100 includes an entity 105. Entity 105 may comprise an application server, a software application, a messaging service (e.g., a mail service), a social networking service, a data center to provide resources from data sources (not shown), and other systems, devices, components, and resources. Entity 105 may be developed and deployed by service provider 110. Service provider 110 may, at least, support or facilitate the maintenance of the application server, application, messaging service (e.g., a mail server), social networking service, data center, or other system, device, component, and resource (e.g., web site) comprising entity 105.

In some instances, entity 105 may included a cloud based application, system, service, or resource that provides a service, resource, and/or access to a service or resource to client devices 115, 120, and 125. Entity 105 may be located remotely from service provider 110 and/or client devices 115, 120, and 125. Communication between the client devices, service provider, and entity 105 may be accomplished using any communication protocol known and that becomes known.

In some embodiments, service provider 110 may operate to monitor entity 105. In particular, service provider 105 may monitor entity 105 in an effort to support and maintain an availability of entity 105 for its intended use by client devices 115, 120, and 125.

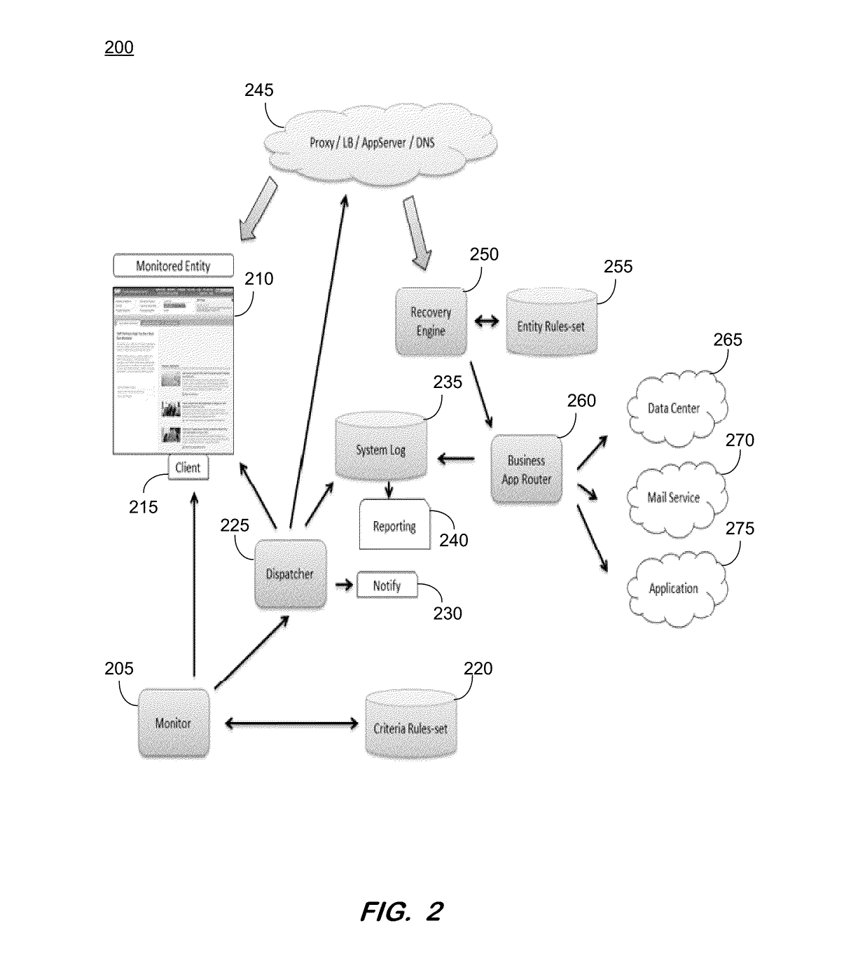

In some embodiments herein, service provider 110 operates to provide and maintain availability of entity 105 by a real-time rule-based platform. FIG. 2 is an illustrative depiction of a logical representation of a real-time rule-based platform 200, including functional representations and abstractions of components comprising the platform, in accordance with some embodiments herein. Platform 200 may, in some embodiments, comprise more, fewer, and other logical and functional components other than those specifically depicted in FIG. 2.

Platform 200 includes a monitor 205 for monitoring a status of entity 210. Entity 210 is also referred to herein, in some instances, as the monitored entity. In some aspects, entity 210 may be any system, component, device, application, service, web site, data source, or other resource that is capable of having its status monitored. In some instances, entity 210 may provide an indication of its status. In some embodiments, entity 210 may communicate with monitor 205 via a communication interface or channel that facilitates a transfer of information between monitored entity 210 and monitor 205. In some instances, monitor 205 may receive information indicative of a status of entity 210 based information output by the monitored entity in a normal operation of the entity. For example, a status of a cloud-based service may be determined by monitor 210 by the monitor's reception of an output of the monitored entity as the monitored entity operates to provide its service to its intended consumers (e.g., the clients depicted in FIG. 1). In some instances, monitor 205 may monitor whether or not entity 210 is “up” or “on”. That is, monitor 205 may monitor entity 210 to determine, at a minimum, whether the monitored entity is operating at all. In some instances, monitor 205 may monitor entity 210 to determine whether specific aspects of a service, function, or feature provided by the monitored entity is being provided to the consumers of the monitored entity.

In some instances, the communication interface between monitored entity 210 and monitor 205 may include an application programming interface (API) of a monitored entity client 215 installed in the monitored entity that communicates with a communication interface of monitor 205. The installed monitored entity client 215 may expose one or more APIs of the monitored entity to the monitor for monitoring. Monitored entity client 215 may be an application, “app”, module, or component installed in, on, or at the monitored entity that provides information indicative of or sufficient for a determination of a status of the monitored entity by monitor 205. For example, monitored entity 210 may be a web site running on a server and monitor 205 may access a database associated with the web site being monitored. In this example, the monitored entity client 215 may have APIs that connect to the components of the monitored entity (i.e., the web site) to receive the desired information (e.g., data values for parameters that indicate a status or other insight into the monitored entity). In some instances, monitored entity client 215 may be installed on a server or other device or system that can provide a communication interface between the monitored entity and the monitor.

In some embodiments, platform 200 may be implemented wherein a particular monitored entity does not have a monitored entity client 215 installed therein. Some of such embodiments may include instances where information indicative of a status of the monitored entity may be received, for example, via a private or public API of the monitored entity, without the use of an installed monitored entity client 215.

In some aspects, monitor 205 communicates with a criteria rules set 220. Criteria rules set 220 includes rules that define the information or data to be received from the monitored entity and used for monitoring purposes. In some aspects, criteria rules set 220 may be implemented in a data base. In some embodiments, a criteria rules set, whether implemented in a database or other embodiments, may include three features. The features of the criteria rules set may include a rule, a threshold, limit, or constraint for the rule, and an action to be performed in an instance the threshold, limit, or constraint specified for the rule is satisfied by the information received from the monitored entity. In some aspects, an action is specified for each rule defined by criteria rules set 220. In some aspects, the features being monitored by monitor 205 relate to an operational status of monitored entity 210. Accordingly, the aspects of the monitored entity being monitored are defined by the criteria rules set and the corresponding actions of the rules define the actions to be performed to maintain and/or restore an availability of the operational status of monitored entity 210.

In some instances, examples of rules included in criteria rules set 220 may include rules stating (1) a central processing unit (CPU) usage percentage cannot exceed X for more than Y seconds, otherwise perform an action; (2) a random access memory (RAM) usage cannot exceed X for more than Y seconds, otherwise allocate an additional cluster of RAM; (3) a hard drive usage cannot exceed X, otherwise perform a certain action T; (4) a “ping” command must return a particular response (i.e., “response code 200”) within X time, otherwise perform a certain task W; and (5) a load of a monitored entity must be X, otherwise perform a specific task Z. Other rules may be specified in a criteria rules set, without limit or loss of generality. In some instances, the criteria rules set may contain data defining, for example, the three features of the rules therein including the rule itself, the threshold or limit, and the action to be performed for each rule. In some embodiments, criteria rules set 220 may not include business logic.

In some aspects, the criteria specified in the rules of criteria rules set 220 define and form a basis for monitor 205 to request specific information (e.g., parameter values) from monitored entity 210. The specific information may be requested via monitored entity client 215 or a private or public API. In some aspects, rules comprising criteria rules set 220 may be configurable by a developer or other administrator or provider entity of platform 200. The rules of criteria rules set 220 may be predefined and implemented in one or more forms including but not limited to an XML (extendable markup language) file, a text file (e.g., “.txt”), tags and metadata, a database, and other forms of structured data and unstructured data.

Monitor 205 may further communicate with dispatcher 225. Dispatcher 225 may include business logic that operates based on the information received by monitor 205 from monitored entity 210 and criteria rules set 220 to determine whether to perform an action in response thereto. The functionality to invoke the action to be performed may be an aspect of a functionality of dispatcher 225. Whereas criteria rules set 220 may strictly contain data, dispatcher 225 may further include business logic to process data and invoke one or more actions.

Examples of actions that may be performed as determined by dispatcher 225 include, but are not limited to (1) in the case a hard drive capacity exceeds X, then delete files from a Y location; (2) in the instance a ping command returns “404” for X seconds continuously, then redirect consumers from the monitored entity to another entity Y; (3) in the instance CPU usage exceeds the specified threshold limit, then redirect consumers to another application or data center; and (4) in the case RAM usage exceeds the specified threshold limit, then dynamically allocate RAM. Dispatcher 225 may receive knowledge of a rule and values relating to the rule. Having this information, the dispatcher may execute the action associated with the rule.

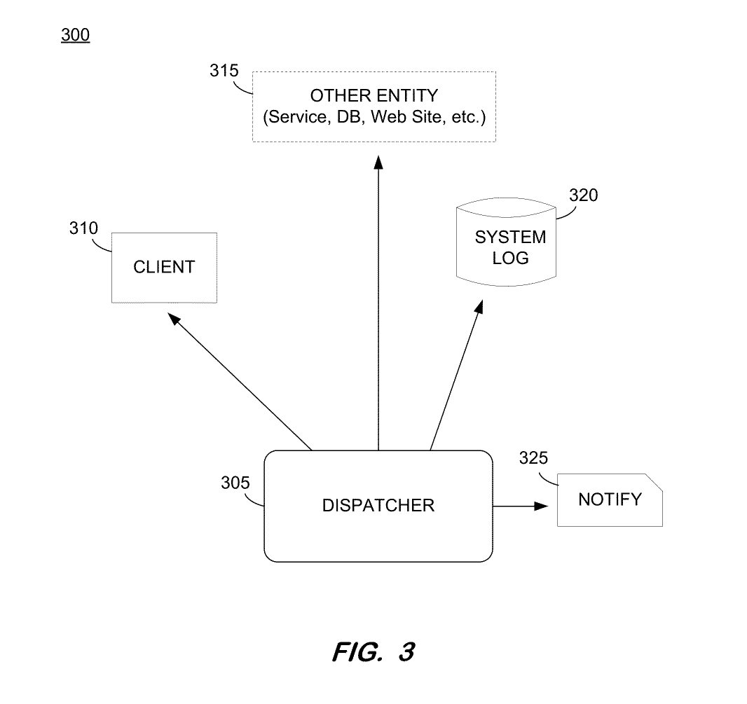

Referring to FIG. 3, an aspect 300 of a platform herein is illustratively depicted. Shown in particular is a dispatcher 305. Based on the receipt of information from a monitor and the criteria rules informing the monitor (not shown in FIG. 3), dispatcher 305 may use business logic it possesses to determine whether a status of the monitored entity warrants repairing an issue with the monitored entity or redirecting a call to the monitored entity to another, different entity. In an instance dispatcher 305 determines it should repair the issue, then the dispatcher may invoke the action(s) needed to fix or repair the issue. In some instances, dispatcher 305 may send instructions or commands to monitored entity client 310 to fix the issue determined to be occurring with the monitored entity. In some instances, dispatcher 305 may determine that availability of the service provided by the monitored entity may be best maintained (e.g., faster recovery from a reduced state of operation) by redirecting a call for the monitored entity to another service, data center, message service, web site, data base, etc. 315.

In some embodiments, dispatcher 305 may provide a notification 325 of the action performed thereby. For example, in an instance dispatcher 305 performs either an action to repair an issue with the monitored entity or to redirect a call to a different entity, the action performed may be reported in a notification 325. Notification 325 may be sent by one or more messages, including but not limited to an email message, a text message, a social networking message, an administrative message, etc.

In some embodiments, dispatcher 305 may provide a record of the action performed thereby to a system log 320. System log 320 may include any type of data store or persistence. For example, system log 320 may be a database, including an in-memory database, accessible to dispatcher 305. In some regards, an entry to system log 320 may include information similar to the contents of notification 325. In some instances, the system log entry may be in a format different than notification 325, notwithstanding the content of the system log entry as compared to notification 325. In some aspects, an entry to system log 320 may provide a mechanism to, for example, provide an accurate history of a status, whether at a specific instance in time or over a period of time, of a monitored entity that may be used to rectify, correct, or avoid a same or similar issue(s) or problem(s) in the monitored entity or other entities in the future.

In an instance the dispatcher (e.g., FIG. 2, 225) redirects a call or request for service from monitored entity 210 to another, different entity, the instruction, message, or command to redirect the call may be sent to recovery engine 250. In some embodiments, the instruction to redirect the call initially intended for monitored entity 210 to the different entity may be controlled by dispatcher 225 and a proxy service 245. Proxy service 245 may be controlled by dispatcher 225 to redirect all calls to recovery engine 250. In some aspects, dispatcher 225 may include predefined logic and functionality to control proxy service 245. In some aspects, dispatcher 245 may be configured to control one or more different types of proxy services, including different types of servers and network management systems. In some aspects, proxy service 245 may operate to redirect HTTP/HTTPS (Hypertext Transfer Protocol/Hypertext Transfer Protocol Secure) calls from monitored entity 210 to recovery engine 250. In some embodiments, redirection services and/or functionality may be facilitated, provided, or implemented by a service, system, device, or apparatus other than proxy service 245.

Recovery engine 250 may communicate with entity rules set 255. Entity rules set 255 may contain rules that define and govern what action(s) are to be performed by recovery engine 250. In some embodiments, recovery engine 250 may obtain the rules of recovery rules set 255 via a request. In some instances, the requests may be implemented as a HTTP Get or a HTTP Post. Entity rules set 255 may include a database that includes information about applications, consumers of a service (e.g., customers and/or clients of the service, etc.), and other entities that may be impacted or accessed by a redirection of a call, request, or other interaction from the monitored entity to a different entity. In some aspects, entity rules set 255 may comprise the data of the rules related to a redirection. In some aspects, a business application router 260 may communicate with recovery engine 250. Business application router 260 may include business logic that may be used to invoke an action related to the redirection action from the monitored entity. In some aspects, business application router 260 may be an abstraction layer that contains executions of the business logic related to the redirection.

As an example, entity rules set 255 may contain rules such as (1) if customer X is redirected, then redirect this customer to a specific maintenance application; (2) if customer Y is redirected, then redirect this customer to a specific data center and also notify customer Y via a notification message; (3) if a HTTP request is from the USA, then redirect this request to a European data center; and (4) if a HTTP request is from the country X, then redirect this request to a data center located in country Y. Other entity rules are possible and within the scope of the present disclosure since, for example, the scope of a rule comprising the entity rules set may be to the parties and/or entities that may interact with or be impacted by a monitored entity.

Business application router 260 may operate to guide a redirect action to a specified data center 265, mail service 270, web site, application 275, or other types and configurations of entities and resources, as specified in entity rules set 255 and further determined and invoked by business application router 260.

In some embodiments, a record of the action performed and executed by business application router 260 may be saved to system log 235. In some embodiments, system log 235 may record a record of the actions performed by both business application router 260 and dispatcher 225. In this manner, some embodiments herein may maintain a persistence of the actions performed by platform 200, including actions executed based on a status of a monitored entity and the actions taken as a result of a redirection from the monitored entity to a different entity. Accordingly, platform 200 may thus generate records that may include the results of determinations that decide what action to perform, if any, based on a status of the monitored entity and the governing criteria rules set related thereto; the particular action taken; the results of determinations that decide what action to perform, if any, based on a redirection from the monitored entity and the governing entity rules set related thereto; and the particular action taken to redirect a call to the different entity. Such record(s) may provide knowledge and insight into the maintenance and availability of a monitored entity such that a provider of the platform (e.g., FIG. 1, service provider 125) may efficiently and automatically maintain a continuous availability of the monitored entity by providing, in some embodiments, a self-contained end-to-end solution to entity availability maintenance.

In some embodiments, system log 235 may represent a business layer abstraction that contains a database schema. In some instances, any action from dispatcher 225 and business application router 260 may be documented in the database via the business layer. In some regards, the business layer may expose API's and connections to have the information related to the actions stored in the database and/or connect to an application or component that includes tools to generate reports, analyze data, generate dashboards, etc. In some instances system log 235 may operate to, for example, generate scheduled reports regarding the availability of a monitored entity (e.g., an application) to a particular customer, including the redirections executed to maintain availability of the service for that customer; generate a report of a customer's satisfaction with a monitored entity; generate a report that includes key performance indicators so that concerned parties (e.g., company managers, customers, shareholder, and other stakeholders) can have a clear view of monitored entity's availability; generate a continuous availability report; generate reports to inform suppliers whether they are meeting there availability (“up-time”) obligations, and other types of reports.

In some embodiments, platform 200 of FIG. 2 may be implemented in one or more servers. It is noted that FIG. 2 represents a logical and functional abstraction of the real-time rule-based recovery platform disclosed herein. As such, the different functionalities depicted in FIG. 2 may be combined into one system, component, or device and in some instances distributed amongst a plurality of systems, components, or devices, where the plurality of systems, components, or devices may form a sub-system or component of another system, component, or device.

In some embodiments, the real-time rule-based recovery platform disclosed herein is not limited to any particular software or hardware configuration, database implementation, operating system, communication protocol, specific type of monitored entity, application server, or network configuration.

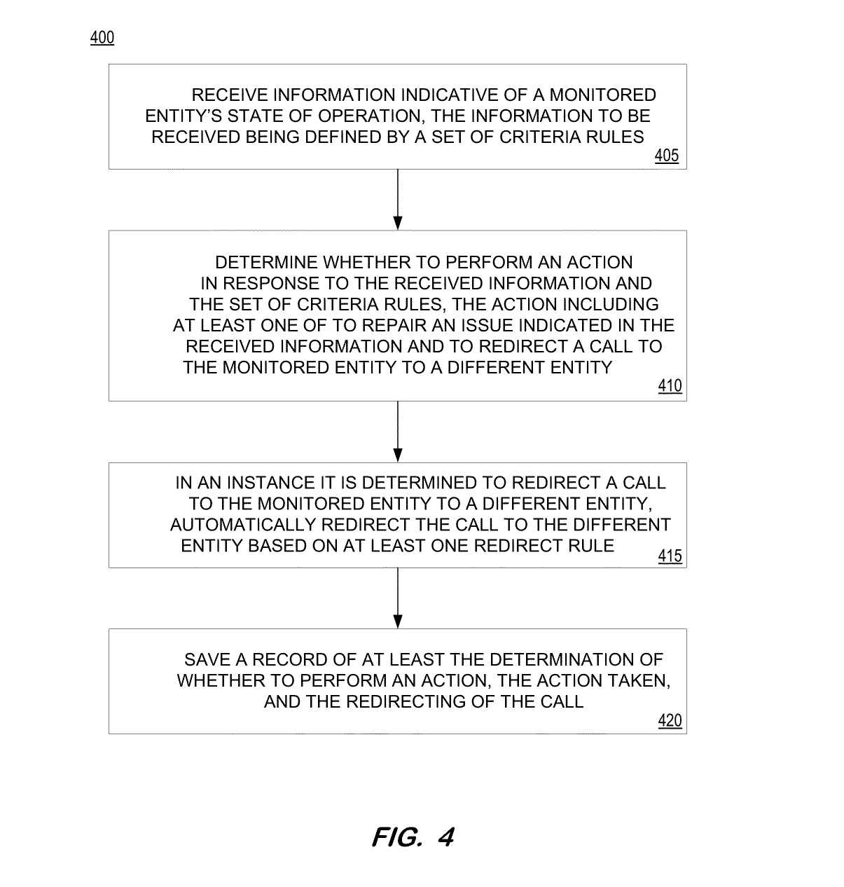

Referring to FIG. 4, a process related to the real-time rule-based recovery platform disclosed herein is shown, generally represented by reference numeral 400. Process 400 may be implemented by a system, application, or apparatus configured to execute the operations of the process. In some embodiments, various hardware elements of system 100 execute program instructions to perform process 400. In some embodiments, hard-wired circuitry may be used in place of, or in combination with, program instructions for implementation of processes according to some embodiments. Program instructions that can be executed by a system, device, or apparatus to implement process 400 (and other processes disclosed herein) may be stored on or otherwise embodied as non-transitory, tangible media. Embodiments are therefore not limited to any specific combination of hardware and software.

Prior to operation 405, a program executing on a device or a server-side computing device (e.g., an application server) may be developed and deployed to one or more device(s) to implement process 400. That is, a number of development and deployment tasks may be performed to establish an initial configuration and initial implementation of a real-time rule-based recovery platform as disclosed herein prior to operation 405. In some embodiments, process 400 may automatically execute subsequent to being developed and deployed.

At operation 405, information is received that may be indicative of a monitored entity's state of operation. In some instances the received information may include data indicative of whether a service provided or the monitored entity is operational (i.e., either on or off). In some instances the received information may include values related to one or more parameters or characteristics of the monitored entity that may be used in determining a status of the monitored entity. The information may be received by a monitor (e.g., FIG. 2, monitor 205) from a monitored entity via one or more of the type connections disclosed herein. The information received at operation 405 may correspond to the type and scope of information defined in a set of criteria rules (e.g., 220) determined in a development of the real-time rule-based recovery platform.

At operation 410, a determination is made whether to perform an action in response to the received information. The determination may be executed based on the received information and the set of criteria rules that include the rules and their associated actions. In some embodiments, a dispatcher (e.g., dispatcher 225 of FIG. 2) may contain business logic that may be used in performing the determination of operation 410. The business logic may analyze and process the data contained in the received information and the data contained in the set of criteria rules. Operation 410 may determine at least whether to repair an issue indicated in the received information and to redirect a call to the monitored entity to a different entity.

In some aspects, an action to repair an issue with the monitored entity may include, at least, adjusting a setting or configuration of the monitored entity, including but not limited to adjusting a level of service provided by the monitored entity. In some embodiments, a repair or fix of the issue may include any action that results in the monitored entity still being responsible for satisfying a call to and/or interactions with the monitored entity.

In some aspects, an action to redirect a call from the monitored entity to a different entity may include, at least, routing the call to a different entity (e.g., a different server, service, web site, data center, social networking site, etc.) In some embodiments, a redirect action may include any action that results in the monitored entity no longer, at least temporarily, being responsible for satisfying a call to or an interaction with the monitored entity.

Process 400 may proceed to operation 415 where, in an instance it is determined that the action to be performed is a redirect action, the call to the monitored entity is automatically redirected to the different entity. The actual action invoked to complete the redirect action may be based, at least in part, on at least one redirect rule. Referring to FIG. 2, a recovery engine 250 may consult redirect rules set 255 to determine the action to be taken and business router engine 260 may execute commands, instructions, a script, and other mechanisms to redirect the call to one or more entities (e.g., 265/270/275) that are different than monitored entity 210.

Operation 420 may include generating and saving a record of at least the determination of whether to perform an action, the action taken (if any), and the redirecting of the call in the instance a redirect action was executed. The record may contain additional details, which may enhance a reporting and analytics feature(s) of the real-time rule-based recovery platform of the present example.

Unless otherwise stated, the resources herein may be of any data type and data structure including, but not limited to, a text file, an image file, an audio file, a structured data file, a video, a file containing unstructured data, a multimedia file, a hypertext markup language file, a message, a notification, a database item or object, combinations thereof, and other data structures without limit.

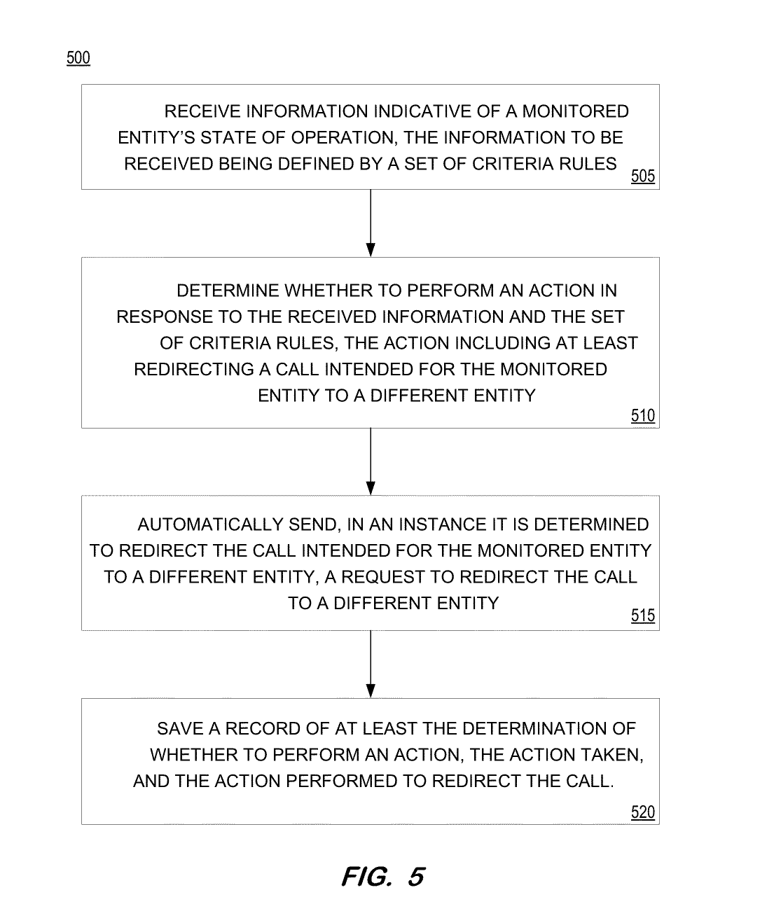

FIG. 5 is a flow diagram of a process 500, in accordance with some embodiments herein. In some embodiments, various hardware elements of system 100 may execute program instructions to perform process 500. In some embodiments, hard-wired circuitry may be used in place of, or in combination with, program instructions for implementation of processes according to some embodiments. Embodiments are therefore not limited to any specific combination of hardware and software.

FIG. 5 may be related to a real-time rule-based recovery platform such as that disclosed herein. Prior to operation 505, an application executing on one or more devices, systems, components, or servers (e.g., an application server) may be developed and deployed to the devices, system, components, or servers to implement process 500. Operation 505 may include receiving information that may be indicative of a monitored entity's state of operation. In some embodiments the received information may include data indicative of whether a service provided by the monitored entity is operational and/or a level of operation being provided by the monitored entity. In some instances the received information may include values related to one or more parameters or characteristics of the monitored entity that may be used in determining a status of the monitored entity. The information may be received by a dispatcher (e.g., FIG. 2, dispatcher 225) from a monitored entity via a monitor and one or more connections to the monitored entity. The information received at operation 505 may correspond to the type and scope of information defined in a set of criteria rules (e.g., 220) determined and defined during, for example, a development time of the real-time rule-based recovery platform.

At operation 510, a determination may be made by the dispatcher of whether to perform an action in response to the received information. The determination may be executed based on the received information and the set of criteria rules that include the rules and their associated actions. In some aspects, the dispatcher may include or have access to business logic that may be used to perform the determination of operation 510. The business logic may be used, in some instances, to analyze and process the data contained in the received information and the set of criteria rules. In some instances and configurations, operation 510 may determine whether to (1) repair as issue determined based on the received information and (2) redirect a call to the monitored entity to a different entity.

In some aspects, an action to repair or fix the issue identified or determined to exist with the monitored entity may include, for example, adjusting a setting or configuration of the monitored entity, including but not limited to adjusting a level of service provided by the monitored entity. In some embodiments, a repair or fix of the issue may include any action that includes the monitored entity still being responsible for satisfying a call to the monitored entity.

In some aspects, an action to redirect a call from the monitored entity to a different entity may include, at least, routing the call to a different entity, where the different entity may include one or more of a different server, service, web site, data center, social networking site, or other entity such as a software application. In some embodiments, a redirect action may include any action that results in the monitored entity no longer being, at least temporarily, responsible for satisfying a call to the monitored entity.

Continuing with process 500, operation 515 may include automatically sending, in an instance it is determined that the action to be performed is a redirect action, a request to redirect the call intended for the monitored entity to a different entity. The request may be sent to a component, module, device, sub-system or other implemented entity that can invoke an execution of the redirect action. In some embodiments, the redirect action may be based, at least in part, on at least one redirect rule and can be sent to, for example, a recovery engine 250 such as that depicted in FIG. 2. The recovery engine may consult redirect rules set 255 and business router engine 260 may execute commands, instructions, a script, and other mechanisms to redirect the call to one or more entities (e.g., 265/270/275) other than the monitored entity 210.

At operation 520, a record of at least the determination of whether to perform an action, the action taken (if any), and the redirecting of the call in the instance a redirect action was executed may be generated and persisted to a data store. The record may contain details in addition to those particularly provided in the present example. Some of those additional details may be used in a reporting and/or analytical feature of the real-time rule-based recovery platform represented, at least in part, by process 500.

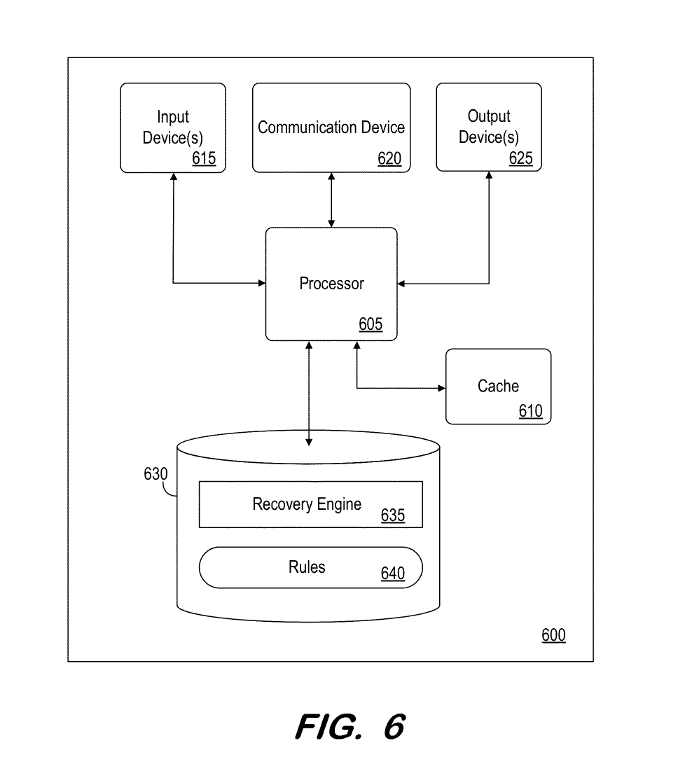

FIG. 6 is a block diagram overview of a system or apparatus 600 according to some embodiments. System 600 may be, for example, associated with any of the devices described herein, including for example a platform of FIG. 2 and aspects thereof (e.g., monitor 205, dispatcher 225, recovery engine 250, etc.), a monitored entity client (e.g., FIG. 1, 215), and a client device (FIG. 1, 115), in accordance with processes disclosed herein. System 600 comprises a processor 605, such as one or more commercially available Central Processing Units (CPUs) in the form of one-chip microprocessors or a multi-core processor, coupled to a communication device 620 configured to communicate via a communication network (not shown in FIG. 6) to another device or system (e.g., a monitored entity). In the instance system 600 comprises a device or system (e.g., supporting a real-time rule-based recovery platform), communication device 620 may provide a mechanism for system 600 to interface with a monitored entity (e.g., an application, device, system, or service). System 600 may also include a cache 610, such as RAM memory modules. The system may further include an input device 615 (e.g., a touchscreen, mouse and/or keyboard to enter content) and an output device 625 (e.g., a touchscreen, a computer monitor to display, a LCD display).

Processor 605 communicates with a storage device 630. Storage device 630 may comprise any appropriate information storage device, including combinations of magnetic storage devices (e.g., a hard disk drive), optical storage devices, solid state drives, and/or semiconductor memory devices. In some embodiments, storage device 630 may comprise a database system, including in some configurations an in-memory database.

Storage device 630 may store program code or instructions 635 that may provide processor executable instructions for managing a recovery engine of a real-time rule-based recovery platform, in accordance with processes herein. Processor 605 may perform the instructions of the program instructions 635 to thereby operate in accordance with any of the embodiments described herein. Program instructions 635 may be stored in a compressed, uncompiled and/or encrypted format. Program instructions 635 may furthermore include other program elements, such as an operating system, a database management system, and/or device drivers used by the processor 605 to interface with, for example, a monitored entity and peripheral devices (not shown in FIG. 6). Storage device 630 may also include data 640 such as rules disclosed in some embodiments herein. Data 640 may be used by system 600, in some aspects, in performing one or more of the processes herein, including individual processes, individual operations of those processes, and combinations of the individual processes and the individual process operations.

All systems and processes discussed herein may be embodied in program code stored on one or more tangible, non-transitory computer-readable media. Such media may include, for example, a floppy disk, a CD-ROM, a DVD-ROM, a Flash drive, magnetic tape, and solid state Random Access Memory (RAM) or Read Only Memory (ROM) storage units. Embodiments are therefore not limited to any specific combination of hardware and software.

In some embodiments, aspects herein may be implemented by an application, device, or system to manage recovery of an entity or other application in a consistent manner across different devices, effectively across an entire domain.

Although embodiments have been described with respect to cloud-based entities, some embodiments may be associated with other types of entities that need not be cloud-based, either in part or whole, without any loss of generality.

The embodiments described herein are solely for the purpose of illustration. Those in the art will recognize other embodiments which may be practiced with modifications and alterations.

1. A method implemented by a computing system in response to execution of program instructions by a processor of the computing system, the method comprising:
receiving information indicative of a monitored entity's state of operation, the information to be received being defined by a set of criteria rules and the monitored entity being at least one of an application server, a software application, a messaging service, a social networking service, and a data center to provide resources from data sources;
determining whether to perform an action in response to the received information and the set of criteria rules, the action including at least one of to repair an issue indicated in the received information and to redirect a call to the monitored entity to a different entity;
in an instance where it is determined to redirect a call to the monitored entity to a different entity, automatically redirecting the call to the different entity based on at least one redirect rule; and
saving a record of at least the determination of whether to perform an action, the action taken, and the redirecting of the call.

2. The method of claim 1, wherein the set of criteria rules comprises a collection of rules having associated limiting values and at least one associated action for each rule.

3. The method of claim 1, further comprising requesting the information, the information including [[the]] limiting values from the monitored entity as defined in the set of criteria rules, wherein the determining of whether to perform an action uses the limiting values received in the information.

4. The method of claim 1, further comprising receiving the information from at least one of a client installed in the monitored entity and an application programming interface.

5. The method of claim 1, further comprising generating a notification including an indication of the determination of whether to perform an action, including the action performed in response to that determination.

6. The method of claim 1, wherein the at least one redirect rule comprises a specific action to perform to redirect the call to the different entity.

7. The method of claim 6, where the specific action to perform to redirect the call to the different entity relates to at least one of a specific type of entity and a specific type of request.

8. A non-transitory medium storing processor-executable program instructions, the medium comprising program instructions executable by a computer to:
receive information indicative of a monitored entity's state of operation, the information to be received being defined by a set of criteria rules and the monitored entity being at least one of an application server, a software application, a messaging service, a social networking service, and a data center to provide resources from data sources;
determine whether to perform an action in response to the received information and the set of criteria rules, the action including at least redirecting a call intended for the monitored entity to a different entity;
automatically send, in an instance where it is determined to redirect the call intended for the monitored entity to a different entity, a request to redirect the call to a different entity;
determine, in response to the request to redirect the call to a different entity, an action to perform based on at least one redirect rule; and
save a record of at least the determination of whether to perform an action, the action taken, and the action performed to redirect the call.

9. The medium of claim 8, wherein the action to perform in response to the received information and the set of criteria rules further comprises repairing an issue indicated in the received information.

10. The medium of claim 8, wherein the request to redirect the call to a different entity is sent to a proxy service.

11. The medium of claim 8, wherein the set of criteria rules comprises a collection of rules having associated limiting values and at least one associated action for each rule.

12. The medium of claim 11, wherein the determining of whether to perform an action uses limiting values associated with the set of criteria rules that are received in the information.

13. The medium of claim 8, further comprising program instructions executable by a computer to generate a notification including an indication of the determination of whether to perform an action, including the specific action to perform in response to that determination.

14. The medium of claim 8, wherein the at least one redirect rule comprises a specific action to perform to redirect the call to the different entity.

15. The medium of claim 14, where the specific action to perform to redirect the call to the different entity relates to at least one of a specific type of entity and a specific type of request.

16. A system comprising:
a computing device comprising:
a memory storing processor-executable program instructions; and
a processor to execute the processor-executable program instructions to cause the computing device to:
receive information indicative of a monitored entity's state of operation, the information to be received being defined by a set of criteria rules and the monitored entity being at least one of an application server, a software application, a messaging service, a social networking service, and a data center to provide resources from data sources;
determine whether to perform an action in response to the received information and the set of criteria rules, the action including at least one of to repair an issue indicated in the received information and to redirect a call to the monitored entity to a different entity;
in an instance where it is determined to redirect a call to the monitored entity to a different entity, automatically redirect the call to the different entity based on at least one redirect rule; and
save a record of at least the determination of whether to perform an action, the action taken, and the redirecting of the call.

17. The system of claim 16, wherein the set of criteria rules comprises a collection of rules having associated limiting values and at least one associated action for each rule.

18. The system of claim 16, wherein the determining of whether to perform an action uses limiting values received in the information and associated with the set of criteria rules.

19. The system of claim 16, wherein the at least one redirect rule comprises a specific action to perform to redirect the call to the different entity.

20. The system of claim 19, where the specific action to perform to redirect the call to the different entity relates to at least one of a specific type of entity and a specific type of request.
